(19) United States
(12) Patent Application Publication
(10) Pub. No.: US 2018/0178384 A1
(43) Pub. Date: Jun. 28, 2018

(54) APPARATUS FOR DETERMINING WHETHER MANIPULATOR IS OPERABLE

(71) Applicant: DENSO WAVE INCORPORATED, Chita-gun (JP)

(72) Inventor: Daisuke KAWASE, Chita-gun (JP)

(73) Assignee: DENSO WAVE INCORPORATED, Chita-gun (JP)

(21) Appl. No.: 15/851,921

(22) Filed: Dec. 22, 2017

(30) Foreign Application Priority Data
Dec. 26, 2016 (JP) 2016-251902

(51) Int. Cl. B25J 9/16; B25J 9/06

(52) U.S. Cl. CPC B25J 9/1674; B25J 13/08; B25J 9/06; B25J 9/1697

(57) ABSTRACT

In an apparatus for determining whether a manipulator is operable, a rotational angle calculator performs, based on a length of each of first and second links at a specified temperature of a manipulator, a calculation operation to calculate a target rotational angle of at least one of the first and second links based on a joint. The target rotational angle of at least one of the first and second links based on operation of the joint is required for a predetermined point of the manipulator to be moved toward a setting movement position. A determiner determines, based on the target rotational angle of at least one of the first and second links, whether the predetermined point of the manipulator is movable to the setting movement position at the specified temperature of the manipulator.

### CROSS REFERENCE TO RELATED APPLICATIONS

This application is based on and claims the benefit of priority from Japanese Patent Application 2016-251902 filed on Dec. 26, 2016, the disclosure of which is incorporated in its entirety herein by reference.

### TECHNICAL FIELD

The present disclosure relates to apparatuses for determining whether a manipulator is operable.

### BACKGROUND

Conventional robot apparatuses include a manipulator, i.e. an arm-like robot, and a controller for controlling movement of the manipulator. When target points to be moved to are taught by an operator to the controller, the controller controls the manipulator such that a predetermined point of the manipulator passes through the target points. For example, Japanese Patent Application Publication No. 2016-144861 discloses such a conventional robot apparatus.

### SUMMARY

Such a manipulator is comprised of a plurality of links and a plurality of joints; each of the joints joins a corresponding adjacent pair of the links such that the adjacent pair of links are rotatable relative to each other. Relative rotations of the links may increase the temperatures of the links. An increase in the temperature of each link may cause the link to thermally expand. This may result in the length of each link changing depending on its temperature.

The inventor of the present disclosure has focused attention on the situation where, if the temperature of at least one link of the manipulator upon target points being taught to the controller is different from the temperature of at least one link of the manipulator upon actual movement of the manipulator through the target points, the controller may have difficulty in causing the predetermined point of the manipulator to pass through the target points.

In view of the circumstances, an exemplary aspect of the present disclosure seeks to provide apparatuses for determining whether a manipulator is operable, each of which is capable of determining whether a predetermined point of the manipulator is movable to a target point at a specified temperature.

According to a first exemplary aspect of the present disclosure, there is provided an apparatus for determining whether a manipulator is operable. The manipulator includes at least a first link, a second link, and at least one joint that joins the first and second links such that the first and second links are rotatable relative to each other about a predetermined rotational axis. The apparatus includes a movement position calculating unit configured to calculate, in a setting mode for setting a target point to which a predetermined point of the manipulator is to be moved, a setting movement position in accordance with a length of each of the first and second links at a temperature in the setting mode and the target point. The setting movement position represents a position to which the predetermined point of the manipulator will be moved at the temperature in the setting mode, the length of each of the first and second links at the temperature in the setting mode being referred to as a setting-mode length. The apparatus includes a rotational angle calculator configured to perform, based on a length of each of the first and second links at a specified temperature of the manipulator, a calculation operation to calculate a target rotational angle of at least one of the first and second links based on operation of the joint. The target rotational angle of at least one of the first and second links based on operation of the joint is required for the predetermined point of the manipulator to be moved toward the setting movement position. The apparatus includes a determiner configured to determine, based on the target rotational angle of at least one of the first and second links, whether the predetermined point of the manipulator is movable to the setting movement position at the specified temperature of the manipulator.

In the manipulator, the first and second links are joined to each other via the at least one joint such that the first and second links are rotatable relative to each other about the predetermined rotational axis. Relative rotations of the first and second links may increase the temperature of each link. An increase of each of the first and second links may cause the corresponding link to thermally expand, resulting in the length of each of the first and second links changing depending on the temperature of the corresponding link.

On the basis of the above circumstances, the movement position calculating unit is adapted to calculate, in the setting mode for setting the target point to which the predetermined point of the manipulator is to be moved, the setting movement position in accordance with the length, i.e. the setting-mode length, of each of the first and second links at the temperature in the setting mode and the target point. The setting movement position represents the position to which the predetermined point of the manipulator will be moved at the temperature in the setting mode.

If the temperature in the setting mode is different from a temperature at the time of using the manipulator, it may be difficult to move the predetermined point of the manipulator to the setting movement position at the using-time temperature. For example, if the setting movement position is set while the first and second links are fully extended to be aligned with each other at a high temperature in the setting mode, it may be difficult to move the predetermined point of the manipulator to the setting movement position at a using-time temperature lower than the high temperature in the setting mode. This is because, for example, the length of each of the first and second links is insufficient to move the predetermined point to the setting movement position.

From this viewpoint, the rotational angle calculator is adapted to perform, based on the length of each of the first and second links at the specified temperature of the manipulator, the calculation operation to calculate the target rotational angle of at least one of the first and second links based on operation of the joint. The target rotational angle of at least one of the first and second links based on operation of the joint is required for the predetermined point of the manipulator to be moved toward the setting movement position.

That is, if the predetermined point of the manipulator is movable to the setting movement position at the specified temperature, the calculation operation enables the target rotational angle of at least one of the first joint and the second joint to be validly calculated. Otherwise, if the predetermined point of the manipulator is not movable to the setting movement position at the specified temperature, it is difficult for the calculation operation to validly calculate the target rotational angle of at least one of the first joint and the second joint.

That is, this configuration of the first exemplary aspect enables whether the predetermined point of the manipulator is movable to the setting movement position at the specified temperature of the manipulator to be determined depending on whether the calculation operation of the angle calculator validly calculates the target rotational angle of at least one of the first joint and the second joint.

This makes it possible to determine whether to move, at the specified temperature of the manipulator, the predetermined point of the manipulator to the setting movement position that was determined at the setting temperature.

As a second exemplary aspect, the determiner is configured to determine that the predetermined point of the manipulator is not movable to the setting movement position at the specified temperature of the manipulator upon at least one of

(1) The calculation operation having difficulty in calculating the target rotational angle of at least one of the first and second links

(2) The target rotational angle of at least one of the first and second links being an invalid angle for the joint

This configuration makes it possible to easily determine that predetermined point of the manipulator is not movable to the setting movement position at the specified temperature of the manipulator.

The determiner according to a third exemplary aspect is configured to determine that the predetermined point of the manipulator is movable to the setting movement position at the specified temperature of the manipulator upon the target rotational angle of at least one of the first and second links being validly calculated by the angle calculator.

This configuration makes it possible to easily determine that the predetermined point of the manipulator is movable to the setting movement position at the specified temperature of the manipulator.

In a fourth exemplary aspect, the target point comprises a plurality of target points that are located on a predetermined trajectory, and the movement position calculating unit is configured to calculate, in the setting mode for setting each target point, a point on the trajectory as the setting movement position.

If the predetermined point of the manipulator is to be moved on an ellipsoidal trajectory or a spline trajectory, it is possible to move the predetermined point of the manipulator to a target point on the ellipsoidal or spline trajectory, but it may be difficult to move the predetermined point of the manipulator to another point on the ellipsoidal or spline trajectory. For example, if there is a point having a large curvature on the ellipsoidal or spline trajectory, which is adjacent to the target point at which the predetermined point of the manipulator is located, it may be difficult to move the predetermined point of the manipulator to the large curvature point.

From this viewpoint, the target point of the fourth exemplary aspect includes the plurality of target points that are located on the predetermined trajectory, such as an ellipsoidal or spline trajectory, and the movement position calculating unit is configured to calculate, in the setting mode for setting each target point, a point on the trajectory as the setting movement position. This configuration therefore enables whether the predetermined point of the manipulator is movable to the setting movement position on the trajectory at the specified temperature of the manipulator to be easily determined.

In the apparatus according to a fifth exemplary aspect, the predetermined point is set to the first link, and the manipulator has a predetermined reference point set to the second link. The apparatus further includes a second determiner configured to perform a comparison between

(1) A minimum distance from the reference point to the setting movement position at the temperature of the setting mode

(2) A length of the first and second links from the reference point to the predetermined point while the first and second links fully extend to be aligned with each other at the specified temperature of the manipulator,

The second determiner is configured to determine, based on the comparison, whether the predetermined point of the manipulator is movable to the setting movement position at the specified temperature of the manipulator.

In a sixth exemplary aspect of the present disclosure, there is provided an apparatus for determining whether a manipulator is operable. The manipulator includes at least a first link, a second link, and at least one joint that joins the first and second links such that the first and second links are rotatable relative to each other about a predetermined rotational axis. The apparatus includes a movement position calculating unit configured to calculate, in a setting mode for setting a target point to which a predetermined point of the first link of the manipulator is to be moved, a setting movement position in accordance with a length of each of the first and second links at a temperature in the setting mode and the target point. The setting movement position represents a position to which the predetermined point of the manipulator will be moved at the temperature in the setting mode. The length of each of the first and second links at the temperature in the setting mode is referred to as a setting-mode length, and the second link having a predetermined reference point set thereto. The apparatus includes a determiner configured to perform a comparison between

1. A minimum distance from the reference point to the setting movement position at the temperature of the setting mode

2. A length of the first and second links from the reference point to the predetermined point while the first and second links fully extend to be aligned with each other at the specified temperature of the manipulator. The determiner determines, based on the comparison, whether the predetermined point of the manipulator is movable to the setting movement position at the specified temperature of the manipulator.

According to each of the fifth and sixth exemplary aspects, the predetermined point is set to the first link, and the manipulator has the predetermined reference point set to the second link. If the setting movement position at the temperature in the setting mode is located to be farther than the predetermined point while the first and second links of the manipulator have the fully extended posture, it may be difficult to move the predetermined point of the manipulator to the setting movement position at the specified temperature.

From this viewpoint, the second determiner of the fifth exemplary aspect, i.e. the determiner of the sixth exemplary aspect, is configured to perform the comparison between

1. The minimum distance, referred to as the setting-mode distance, from the reference point to the setting movement position at the temperature of the setting mode

2. The length, referred to as the manipulator maximum length at the specified temperature, of the first and second links from the reference point to the predetermined point while the first and second links fully extend to be aligned with each other at the specified temperature of the manipulator.

Then, the second determiner of the fifth exemplary aspect, i.e. the determiner of the sixth exemplary aspect, determines, based on the comparison, whether the predetermined point of the manipulator is movable to the setting movement position at the specified temperature of the manipulator.

This enables whether the predetermined point of the manipulator is movable to the setting movement position at the specified temperature of the manipulator to be more easily and more rapidly determined.

That is, the above configuration, which performs the above determination based on the setting-mode distance and the manipulator maximum length at the specified temperature, enables the determination of whether the predetermined point of the manipulator is movable to the setting movement position at the specified temperature of the manipulator to be simplified. This results in reduction of time required to finally obtain whether the predetermined point of the manipulator is movable to the setting movement position at the specified temperature of the manipulator.

For example, an introduction procedure of a robot system including such a manipulator requires a high staff workload, such as initial teaching or calibration of the manipulator. From this viewpoint, if the apparatus according to the fifth exemplary aspect or the sixth exemplary aspect is applied to such an introduction procedure of a robot system, it is possible to reduce the required workload. This makes it possible to efficiently introduce a robot system including a manipulator into various industrial fields. This enables robot systems each introducing the apparatus according to the fifth exemplary aspect or the sixth exemplary aspect to obtain significant advantage.

Specifically, the determiner of a seventh exemplary aspect is configured to determine that the predetermined point of the manipulator is not movable to the setting movement position at the specified temperature of the manipulator upon the minimum distance from the reference point to the setting movement position at the temperature of the setting mode being longer than the length of the first and second links from the reference point to the predetermined point while the first and second links fully extend to be aligned with each other at the specified temperature of the manipulator.

This makes it possible to easily determine that the predetermined point of the manipulator is not movable to the setting movement position at the specified temperature of the manipulator.

Additionally, the determiner of an eighth exemplary aspect is configured to determine that the predetermined point of the manipulator is movable to the setting movement position at the specified temperature of the manipulator upon the minimum distance from the reference point to the setting movement position at the temperature of the setting mode being equal to or shorter than the length of the first and second links from the reference point to the predetermined point while the first and second links fully extend to be aligned with each other at the specified temperature of the manipulator.

This makes it possible to easily determine that the predetermined point of the manipulator is movable to the setting movement position at the specified temperature of the manipulator.

The apparatus according to a ninth exemplary aspect includes an information providing unit configured to provide, to a user of the manipulator, information representing that the predetermined point of the manipulator is not movable to the setting movement position at the specified temperature of the manipulator upon determination that the predetermined point of the manipulator is not movable to the setting movement position at the specified temperature of the manipulator.

This enables a user to check whether the predetermined point of the manipulator is movable to the setting movement position at the specified temperature of the manipulator during the setting mode. This reduces the occurrence of need to teach the target point again, and reduces the possibility of the manipulator malfunctioning after installation of the manipulator into one of various facilities.

An information providing unit according to a tenth exemplary aspect is configured to provide, to a user of the manipulator, information representing a threshold temperature of the manipulator on or above which it is difficult to move the predetermined point of the manipulator to the setting movement position upon determination that the predetermined point of the manipulator is not movable to the setting movement position at the specified temperature of the manipulator.

This enables a user to easily determine whether the predetermined point of the manipulator is movable to the setting movement position on the basis of an ambient temperature of the manipulator and/or the usage conditions of the manipulator.

An information providing unit according to an eleventh exemplary aspect is configured to provide, to a user of the manipulator, information representing a correction angular direction in which a rotational angle of at least one of the first and second links used to set the target point in the setting mode should be corrected upon determination that the predetermined point of the manipulator is not movable to the setting movement position at the specified temperature of the manipulator.

This makes it possible for a user to easily know, when setting a target point in the setting mode, the correction angular direction of the rotational angle of at least one of the first and second links; the correction angular direction enables the predetermined point of the manipulator to be moved to the setting movement position.

An information providing unit according to a twelfth exemplary aspect is configured to provide, to a user of the manipulator, information representing a correction angular direction in which an angular correction amount of at least one of the first and second links used to set the target point in the setting mode should be corrected upon determination that the predetermined point of the manipulator is not movable to the setting movement position at the specified temperature of the manipulator.

This enables a user to easily know, when setting a target point in the setting mode, the angular correction amount of the rotational angle of at least one of the first and second links; the angular correction amount enables the predetermined point of the manipulator to be moved to the setting movement position.

An information providing unit according to a thirteenth exemplary aspect is configured to provide, a user of the manipulator, information representing a correction direction in which the target point in the setting mode should be corrected upon determination that the predetermined point of the manipulator is not movable to the setting movement position at the specified temperature of the manipulator.

This enables a user to easily know, when setting a target point in the setting mode, the correction direction of the target point; the correction direction enables the predetermined point of the manipulator to be moved to the setting movement position.

An information providing unit according to a fourteenth exemplary aspect is configured to provide, a user of the manipulator, information representing a correction amount to which the target point in the setting mode should be corrected upon determination that the predetermined point of the manipulator is not movable to the setting movement position at the specified temperature of the manipulator.

This enables a user to easily know, when setting a target point in the setting mode, the correction amount of the target point; the correction amount of the target point enables the predetermined point of the manipulator to be moved to the setting movement position.

### BRIEF DESCRIPTION OF THE DRAWINGS

Other aspects of the present disclosure will become apparent from the following description of embodiments with reference to the accompanying drawings in which:

FIG. 1 is a schematic structural view schematically illustrating a robot system according to the first embodiment of the present disclosure;

FIG. 2 is a flowchart schematically illustrating a robot arm positioning routine carried out by a controller illustrated in FIG. 1;

FIG. 3 is a schematic view schematically illustrating a robot arm having a fully extended posture immediately after power-on of the controller;

FIG. 4 is a schematic view schematically illustrating the robot arm having the fully extended posture after the robot arm has warmed up;

FIG. 5 is a schematic view schematically illustrating the robot arm having a fully bent posture immediately after power-on of the controller;

FIG. 6 is a schematic view schematically illustrating the robot arm having the fully bent posture after the robot arm has warmed up;

FIG. 7A is a flowchart schematically illustrating a specific robot arm positioning routine carried out by the controller illustrated in FIG. 1;

FIG. 7B is a flowchart schematically illustrating the specific robot arm positioning routine carried out by the controller illustrated in FIG. 1;

FIGS. 8A and 8B are a joint schematic view schematically illustrating inverse transformation of a setting movement position to target rotational angles of first and second links of the robot arm that has the fully extended posture according to the first embodiment;

FIGS. 9A and 9B are a joint schematic view schematically illustrating inverse transformation of the setting movement position to the target rotational angles of the first and second links of the robot arm that has a bent posture according to the first embodiment; and

FIG. 10 is a schematic view schematically illustrating a spline trajectory and target points on the spline trajectory according to the first embodiment.

### DETAILED DESCRIPTION OF EMBODIMENT

The following describes embodiments of the present disclosure with reference to the accompanying drawings. In the embodiments, like parts between the embodiments, to which like reference characters are assigned, are omitted or simplified to avoid redundant description.

### First Embodiment

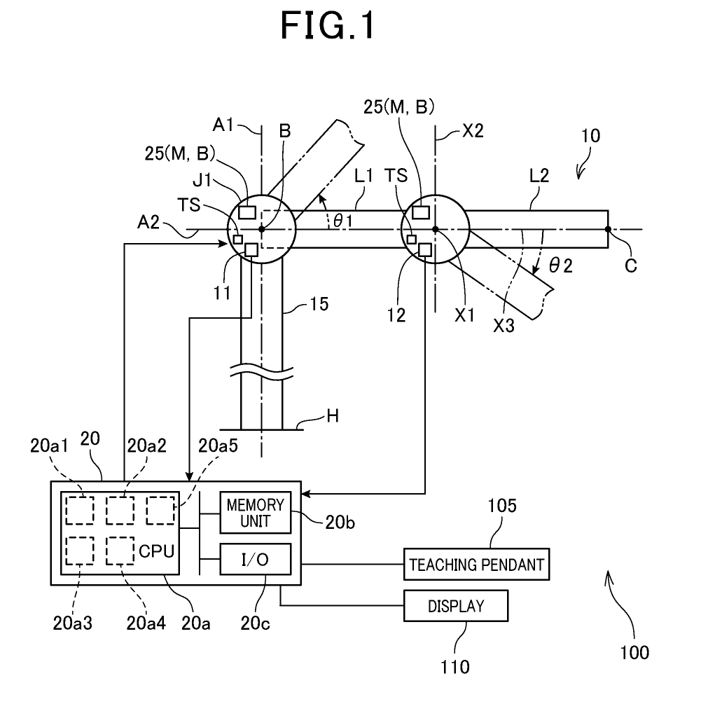

The following describes the first embodiment of the present disclosure, to which the present disclosure has been applied, with reference to FIGS. 1 to 8.

FIG. 1 schematically illustrates a robot system 100 according to the first embodiment. The robot system 100 includes a robot arm 10, which is an example of a manipulator, and a controller 20 for controlling the robot arm 10.

The robot arm 10 is comprised of a base pole 15 mounted at its first end on, for example, a horizontal base surface H of a workshop or the like. The base pole 15 for example extends from the base surface H vertically, and has a predetermined height with respect to the base surface H. The base pole 15 for example has a substantially cylindrical shape, and is preferably rotatable about its center axis, i.e. its vertical axis.

The robot arm 10 is also comprised of a first joint J1, a first link L1, a second joint J2, and a second link L2.

The first joint J1 is mounted to the second end of the base pole 15. The first joint J1 has a vertical axis A1 coaxial to the vertical axis of the base pole 15, and a predetermined horizontal axis A2 perpendicular to the vertical axis A1.

The first link L1, which is a rigid part of the robot arm 10, has a substantially rod shape and has opposing first and second ends. The first end of the first link L1 is joined to the first joint J1 such that the first link L1 is rotatable about a predetermined point of the first joint J1 in a two-dimensional plane defined by the vertical axis A1 and the horizontal axis A2. The second end of the first link L1 is joined to the second joint J2.

The second joint J2 has a rotational axis X1, a vertical axis X2 perpendicular to the rotational axis X1, and a predetermined horizontal axis X3 perpendicular to the rotational axis X1 and the vertical axis X2.

The second link L2, which is a rigid part of the robot arm 10, has a substantially rod shape and has opposing first and second ends. The first end of the second link L2 is joined to the second joint J2 such that the second link L2 is rotatable about the rotational axis X1 of the second joint J2 in a two-dimensional plane defined by the vertical axis X2 and the horizontal axis X3 corresponding to the two-dimensional plane defied by the vertical and horizontal axes A1 and A2. The second end of the second link L2 serves as an end effector. That is, the second joint J2 connects the first and second links L1 and L2 such that the first and second links L1 and L2 are rotated relative to each other in the two-dimensional plane.

Each of the first and second links L1 and L2 is made of a predetermined material having a predetermined thermal expansion coefficient. Each of the first and second links L1 and L2 has a predetermined reference length in its longitudinal direction at a predetermined reference temperature. For example, each of the first and second links L1 and L2 has a reference length of 500.0 mm in its longitudinal direction at a predetermined reference temperature of 40° C.

The first joint J1 is comprised of a bearing and a rotating shaft rotatably supported by the bearing; the rotating shaft is linked to the first end of the first link L1 such that the first link L1 is rotatable with the rotating shaft. The second joint J2 is also comprised of a bearing linked to the second end of the first link L1, and a rotating shaft rotatably supported by the bearing; the rotating shaft is linked to the first end of the second link L2 such that the second link L2 is rotatable with the rotating shaft.

Each of the first and second joints J1 and J2 also includes a driver 25 comprised of a motor M and a brake mechanism B. In the first joint J1, the motor M is coupled to the rotating shaft and is capable of rotating the rotating shaft to thereby rotate the first link L1, and the brake mechanism, referred to simply as a brake, B is capable of braking the rotating shaft, i.e. the first link L1. Similarly, in the second joint J2, the motor M is coupled to the rotating shaft and is capable of rotating the rotating shaft to thereby rotate the second link L2, and the brake B is capable of braking the rotating shaft, i.e. the second link L2.

The first end of the first link L1 has a predetermined reference point B that is defined as the base point for movement of the first and second links L1 and L2. For example, each of the first and second ends of the first link L1 has a rectangular or circular end surface, and the end surface of the first end of the first link L1 has a center that serves as the reference point B. The second end of the first link L1 has a predetermined point C that is defined as a positioning point of the robot arm 10. For example, the end surface of the second end of the first link L1 has a center that serves as the positioning point C.

The first joint J1 includes an encoder 11, and the second joint J2 includes an encoder 12.

The encoder 11 measures a rotational angle of the rotating shaft of the first joint J1, thus measuring a rotational angle θ1 of the first link L1 relative to a reference axis. In the first embodiment, the horizontal axis A2 of the first joint J1 is defined as the reference angle. That is, the encoder 11 measures the rotational angle θ1 of the first joint J1 relative to the reference axis A2.

The encoder 12 measures a rotational angle of the rotating shaft of the second joint J2, thus measuring a rotational angle θ2 of the second link L2 relative to the rotational axis X1. That is, the encoder 12 measures the rotational angle θ2 of the second joint J2 relative to the rotational axis X1.

Each of the encoders 11 and 12 is configured to output, to the controller 20, a measurement signal indicative of the corresponding one of the rotational angles θ1 and 02.

Each of the first and second joints J1 and J2 also includes a temperature sensor TS. Each of the temperature sensors TS measures the temperature of the corresponding one of the encoders 11 and 12, thus measuring the temperature of the motor of the corresponding driver 25. Then, each of the temperature sensors TS is configured to output, to the controller 20, a measurement signal indicative of the corresponding one of the encoders 11 and 12.

The controller 20 is controllably connected to the driver 25, i.e. the motor M and brake B, of each of the first and second joints J1 and J2. The controller 20 controls the motor M and brake B of each of the first and second joint J1 and J2 to thereby control motion of each of the first and second links L1 and L2.

Referring to FIG. 1, the controller 20 is comprised of a microcomputer including a CPU 20a, a memory unit 20b, which is comprised of, for example, a ROM and a RAM, and an input/output (I/O) interface, simply illustrated by I/O, 20c. The CPU 20a of the controller 20 for example can run one or more programs, i.e. program instructions, stored in the memory unit 20b, thus implementing various control tasks as software operations. As another example, the CPU 20a of the controller 20 can include a specific hardware electronic circuit to implement the various control tasks as hardware operations.

The robot system 100 also includes a teaching pendant 105 remotely connected to the controller 20. The teaching pendant 105 is configured as a user operable terminal to input, when operated by a user, various commands, such as a start command and a stop command for the robot arm 10, to the controller 20, and to input target points to which the positioning point C of the robot arm 10 should be moved to the controller 20. The teaching pendant 105 includes an audio-visual output unit for providing audible or visible information to a user when being used by the user. Note that each target point is a point in a predetermined three-dimensional coordinate system by the rotational axis X1, the vertical axis X2, and the horizontal axis X3. The controller 20 of the robot system 100 is configured to store the three-dimensional coordinate system in the memory unit 20b. The horizontal axis X3 is in alignment with the horizontal axis A2. The position, i.e. the coordinates, in the three-dimensional coordinate system is defined to be stored in the memory unit 20b.

The robot system 100 further includes a display 110 connected to the controller 20. The display 110 is configured to display various pieces of information supplied from the controller 20.

When a target point is input from the teaching pendant 105 to the controller 20, the controller 20 is configured to control the motor M and brake B of each of the first and second joints J1 and J2 in accordance with the measurement signals sent from the respective encoders 11 and 12 and temperature sensors TS to thereby move the positioning point C toward the target point taught by the teaching pendant 105. A rotational angle of the first link L1 and a rotational angle of the second link L2 required for the positioning point C to the target point taught by the teaching pendant 105 will be referred to as teaching angles hereinafter.

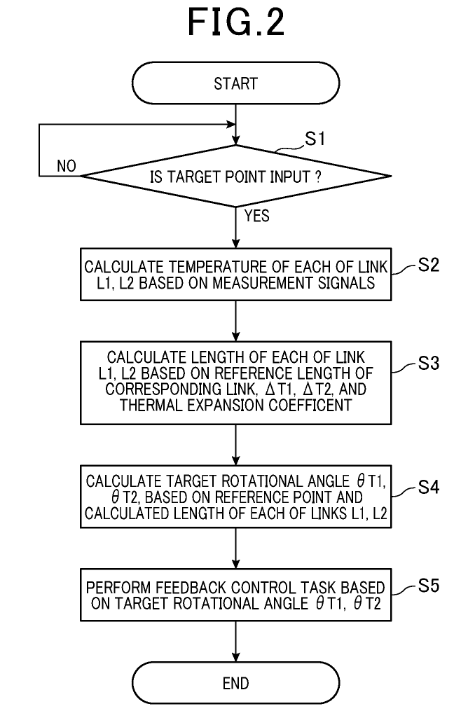

When powered on by a user, the controller 20 performs the following robot arm positioning routine illustrated in FIG. 2.

Specifically, when a target point taught by the teaching pendant 105 is input to the controller 20 in a teaching mode (YES in step S1), the controller 20 receives the target point, and calculates a temperature of each of the first and second links L1 and L2 in accordance with the measurement signals sent from the temperature sensors TS in step S2. For example, the controller 20 can take the measured temperature of the encoder 11 as the temperature of the first link L1, and the measured temperature of the encoder 12 as the temperature of the second link L2. The controller 20 can also calculate the temperature of the first link L1 using a predetermined relationship between the temperature of the first link L1 and the measured temperature of the encoder 11, and calculate the temperature of the second link L2 using a predetermined relationship between the temperature of the second link L2 and the measured temperature of the encoder 12.

Next, the controller 20 calculates the first difference ΔT1 between the temperature of the first link L1 and the reference temperature, and the second difference ΔT2 between the temperature of the second link L2 and the reference temperature in step S3.

Then, in step S3, the controller 20 calculates an actual length of each of the first and second links L1 and L2 in accordance with

(1) The reference length of the corresponding one of the first and second links L1 and L2 at the reference temperature

(2) The corresponding one of the first and second differences ΔT1 and ΔT2

(3) The thermal expansion coefficient of the corresponding one of the first and second links L1 and L2

Following the operation in step S3, the controller 20 calculates, based on the position of the reference point B, the position of the target point, and the calculated actual length of each of the first and second links L1 and L2, a target rotational angle θT1 for the first joint J1 and a target rotational angle θT2 for the second joint J2 in an actual movement mode in step S4. The target rotational angles θT1 and θT2 are required for the positioning point C of the robot arm 10 to be moved to the target point.

In other words, the controller 20 performs an inverse transform of the target position to the target rotational angle θT1 and target rotational angle θT2 using the position of the reference point B and the calculated actual length of each of the first and second links L1 and L2 in the actual movement mode in step S4.

Then, in step S5, the controller 20 performs, in the actual movement mode, a feedback control task that controls the motor M of each of the first and second joints J1 and J2 such that

(1) The deviation of the actual rotational angle θ1 of the first link L1, which is fed back from the encoder 11, from the target rotational angle θT1 becomes zero to thereby match the actual rotational angle θ1 with the target rotational angle θT1

(2) The deviation of the actual rotational angle θ2 of the second link L2, which is fed back from the encoder 12, from the target rotational angle θT2 becomes zero to thereby match the actual rotational angle θ2 with the target rotational angle θT2

In step S4, the controller 20 can perform transform of the actual rotational angle θ1 of the first link L1 and the actual rotational angle θ2 of the second link L2 to thereby calculate the location of the positioning point C.

Let us consider that, immediately after power-on of the controller 20, i.e. before the robot arm 10 has warmed up, the actual length of each of the first and second links L1 and L2 is shorter than the reference length of the corresponding one of the first and second links L1 and L2.

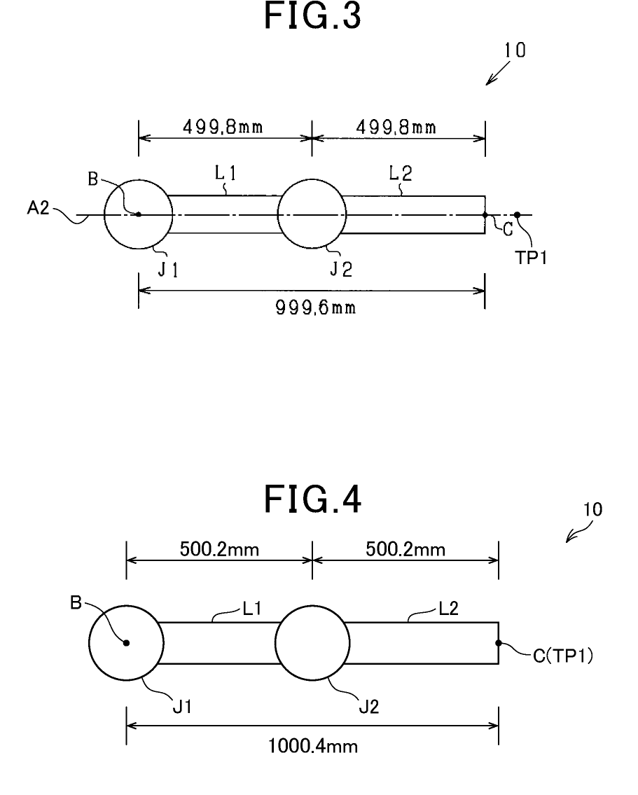

Specifically, as illustrated in FIG. 3, when the temperature of each of the first and second links L1 and L2 is for example 20° C. immediately after power-on of the controller 20, the actual length of each of the first and second links L1 and L2 is 499.8 mm that is shorter than the reference length of 500.0 mm of the corresponding one of the first and second links L1 and L2 at the reference temperature of 40° C.

Note that FIG. 3 and some figures described hereinafter each schematically show the robot arm 10 in order to simply illustrate the robot arm 10.

As illustrated in FIG. 3, it is assumed that the robot arm 10 has a predetermined fully extended posture that the rotational angles θ1 and 02 are zero, so that the first link L1 and the second link L2 fully extend to be aligned with each other along their horizontal axes A2 and X3.

In contrast, when a sufficient time has elapsed since power-on of the controller 20, i.e. after the robot arm 10 has warmed up, the actual length of each of the first and second links L1 and L2 is longer than the reference length of the corresponding one of the first and second links L1 and L2.

Specifically, as illustrated in FIG. 4, when the temperature of each of the first and second links L1 and L2 is for example 60° C. after the robot arm 10 has warmed up, the actual length of each of the first and second links L1 and L2 of the robot arm 10 having the fully extended posture is 500.2 mm that is longer than the reference length of 500.0 mm of the corresponding one of the first and second links L1 and L2 at the reference temperature of 40° C.

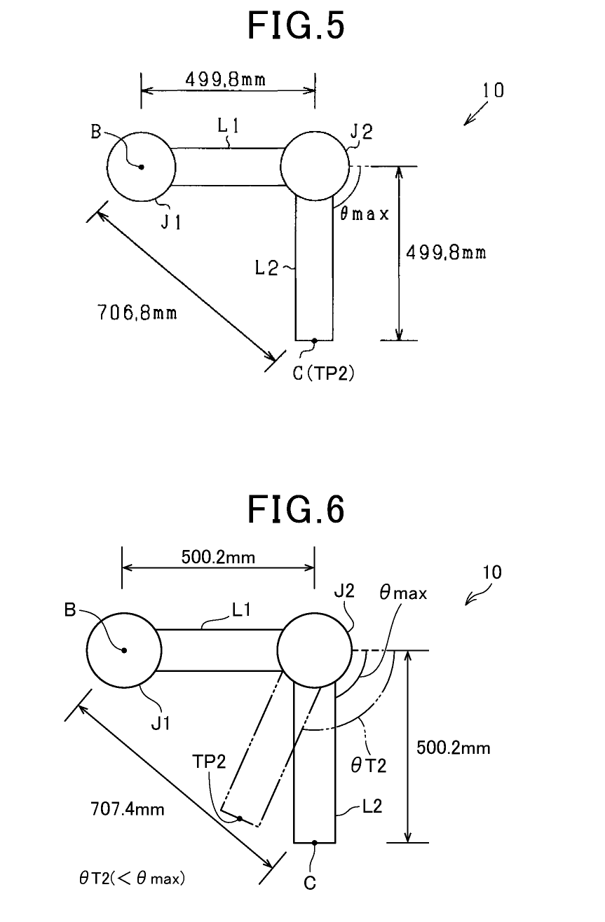

For this reason, if a target point TP1 is taught to the controller 20 at the temperature of each of the first and second links L1 and L2 being set to 60° C. in the teaching mode while the robot arm 10 has the fully extended posture as illustrated in FIG. 4, the controller 20 may not cause the robot arm 10 at the temperature of each of the first and second links L1 and L2 being set to 20° C. in the actual movement mode to move the positioning point C of the robot arm 10 to the target point TP1 (see FIG. 3). Note that, although actual dimensional differences between the robot arm 10 illustrated in FIG. 3 and the robot arm 10 illustrated in FIG. 4, FIGS. 3 and 4 illustrate the actual dimensional differences in large scale. FIGS. 5 and 6, FIGS. 8A and 8B, and FIGS. 9A and 9B also each illustrate the actual dimensional differences in large scale.

In this case, the controller 20 determines that the controller 20 cannot calculate, based on the position of the reference point B, the position of the target point TP1, and the calculated actual length of each of the first and second links L1 and L2, the target rotational angle θT1 for the first joint J1 and the target rotational angle θT2 for the second joint J2 in step S4. In other words, the controller 20 determines that no target angles for the first and second links L1 and L2 satisfy the target point TP1 in step S4.

Additionally, it is assumed that an upper limit rotational angle, i.e. a maximum rotational angle, θmax for the rotational angle θ2 of the second link L2 relative to the horizontal axis X3 is previously established as 90° C., which is an example in the first embodiment. This prevents the second link L2 from hitting another portion of the robot arm 10 or other objects located around the robot arm 10. The posture where the rotational angle θ2 of the second link L2 relative to the horizontal axis X3 is set to the maximum rotational angle θmax while the rotational angle θ1 of the first link L1 relative to the horizontal axis A2 being set to zero will be referred to as a fully bent posture.

It is assumed that a target point TP2 is taught to the controller 20 at the temperature of each of the first and second links L1 and L2 being 20° C. while the robot arm 10 has a fully bent posture as illustrated in FIG. 5.

In this assumption, the controller 20 may not cause the robot arm 10 at the temperature of each of the first and second links L1 and L2 being 60° C. in the actual movement mode to move the positioning point C of the robot arm 10 to the target point TP2 even if the rotational angle θ2 of the second link L2 is set to the upper limit rotational angle θmax (see FIG. 6).

In this assumption, the controller 20 determines that the controller 20 can calculate, based on the position of the reference point B, the position of the target point TP2, and the calculated actual length of each of the first and second links L1 and L2, the target rotational angle θT1 for the first joint J1 and the target rotational angle θT2 for the second joint J2 in step S4. However, the controller 20 determines that the calculated target rotational angle θT2 for the second joint J2 cannot be established by the second joint J2.

Note that the above descriptions show an issue occurring in the case where the temperature of the robot arm 10 in the teaching mode is changed to another temperature of the robot arm 10 in the actual movement mode due to the warm-up operation of the robot arm 10, but the causes of the temperature change of the robot arm 10 are not limited to the warm-up operation of the robot arm 10.

For example, if the operation environment around the robot arm 10 in the teaching mode is changed to another operation environment around the robot arm 10 in the actual movement mode, so that the temperature around the robot arm 10 in the teaching mode is changed to another temperature around the robot arm 10 in the actual movement mode, this case may result in the above issue. Additionally, if the temperature of the robot arm 10 in the teaching mode is changed to another temperature of the robot arm 10 in the actual movement mode due to seasonal factors, this case may also result in such an issue. Moreover, if the operating state, i.e. the heating state, of the robot arm 10 in the teaching mode is changed to another temperature of the robot arm 10 in the actual movement mode, this case may result in the above issue.

For addressing such an issue, the controller 20 is specially configured described hereinafter. The following describes the specific configuration of the controller 20 with reference to FIGS. 1, 7, 8A, 8B, 9A, 9B, and 10.

The CPU 20a of the controller 20 functionally includes a movement position calculating module 20a1, a rotational angle calculator 20a2, a determiner 20a3, and an information providing module 20a4.

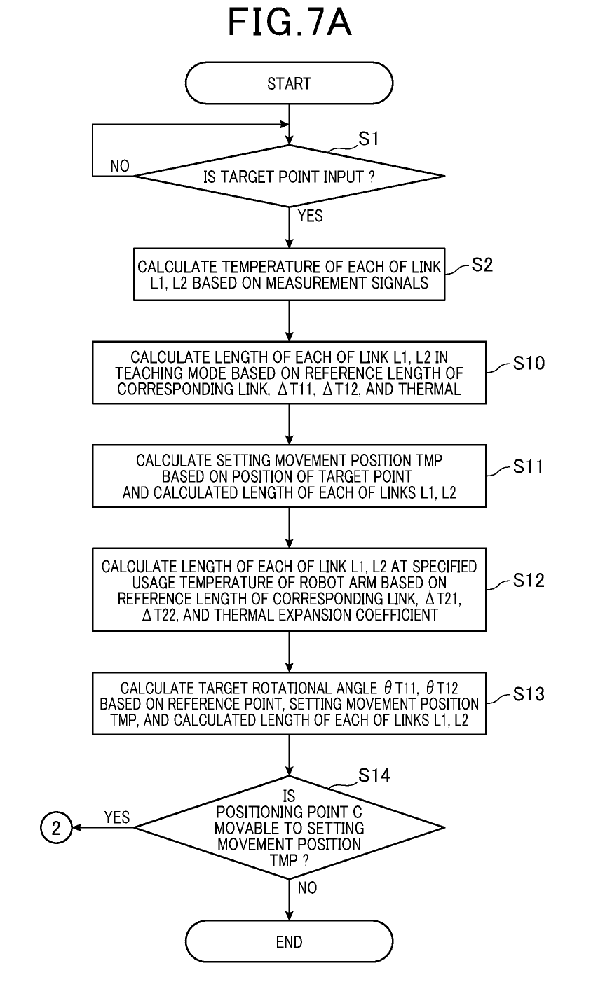

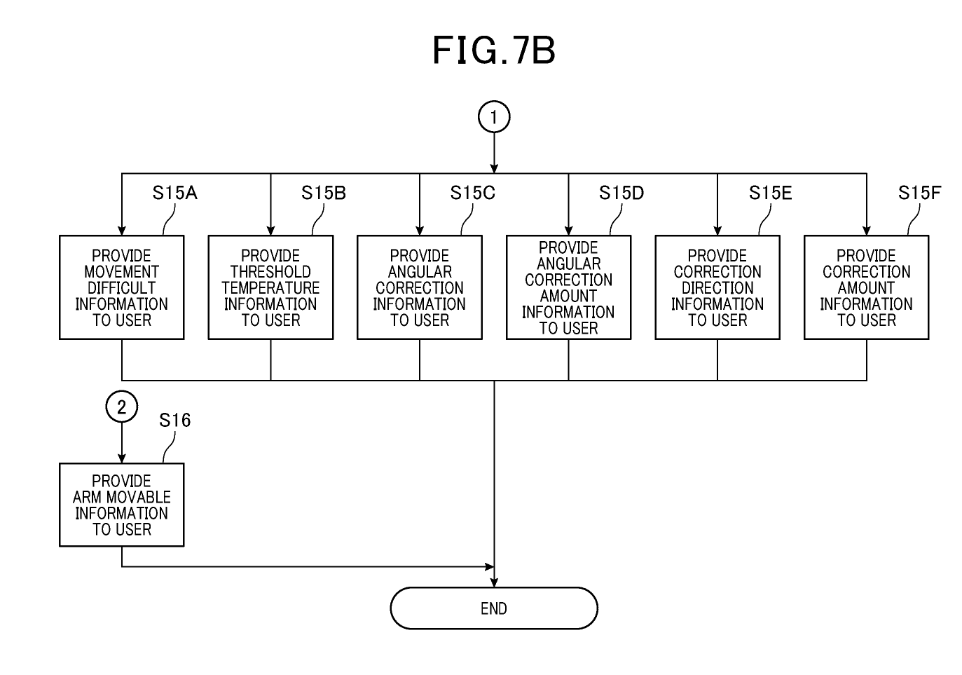

When powered on by a user, the controller 20 performs a specific robot arm positioning routine illustrated in FIGS. 7A and 7B.

When a target point taught by the teaching pendant 105 is input to the controller 20 in the teaching mode (YES in step S1 of FIG. 7A), the controller 20 performs the operation in step S2, to thereby calculate a temperature, i.e. a teaching-mode temperature, for example, 60° C., of each of the first and second links L1 and L2 in the teaching mode.

Next, in step S10, the controller 20 calculates a temperature difference ΔT11 between the teaching-mode temperature of the first link L1 and the reference temperature, and a temperature difference ΔT12 between the teaching-mode temperature of the second link L2 and the reference temperature.

Then, in step S10, the controller 20 calculates an actual length of each of the first and second links L1 and L2 in the teaching mode in accordance with

(1) The reference length at the reference temperature of the corresponding one of the first and second links L1 and L2

(2) The corresponding one of the temperature differences ΔT11 and ΔT12

(3) The thermal expansion coefficient of the corresponding one of the first and second links L1 and L2

That is, the controller 20 calculates the actual length of each of the first and second links L1 and L2 at the teaching mode temperature of 60° C. of the corresponding one of the first and second links L1 and L2 in the teaching mode in step S10.

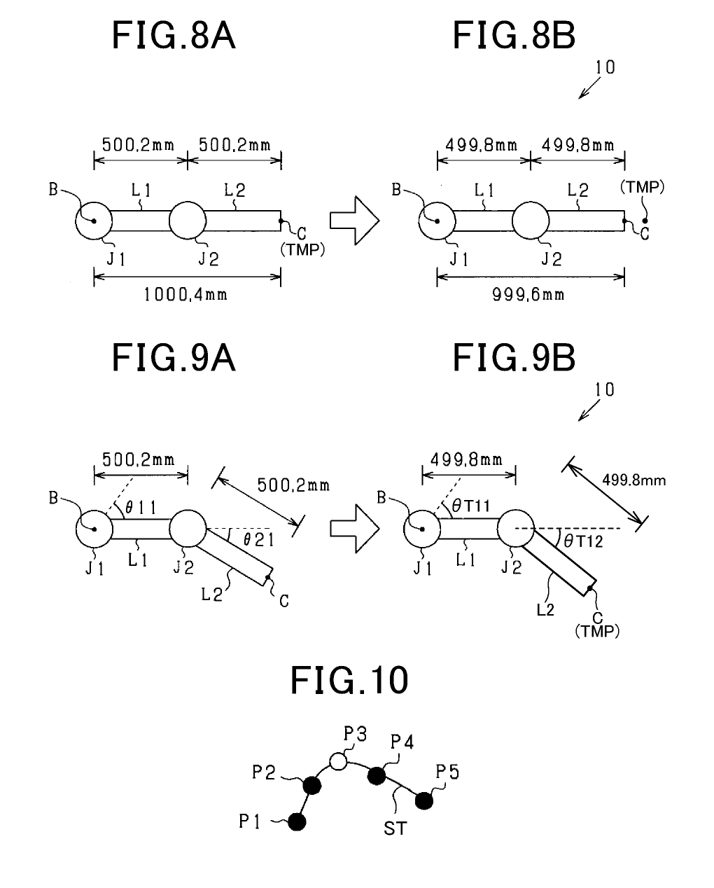

Following the operation in step S10, the controller 20 serves as, for example, the movement position calculating module 20a1 to calculate, based on the position of the target point and the calculated length of each of the first and second links L1 and L2, a setting movement position TMP to which the positioning point C of the robot arm 10 actually moves in the teaching mode in step S11 (see an example of FIG. 8A and another example of FIG. 9A). Note that the rotational angle θ11 in FIG. 9A represents the teaching angle of the first link L1 in the teaching mode, and the rotational angle θ21 in FIG. 9A represents the teaching angle of the second link L2 in the teaching mode.

If sequential target points taught by the teaching pendant 105 are input to the controller 20 in the teaching mode for linear movement of the positioning point C (YES in step S1), the controller 20 can calculate, based on the position of each of the sequential target points and the calculated length of each of the first and second links L1 and L2, the setting movement position TMP for each of the sequential target points in step S11.

Note that, as illustrated in FIG. 10, there is a case where sequential target points P1, P2, P4, and P5 are taught by the teaching pendant 105 are input to the controller 20 in the teaching mode for a spline movement of the positioning point C along a spline trajectory ST. That is, the spline trajectory ST is defined as a curve that passes through the sequential target points P1, P2, P4, and P5. In this case, it may be difficult to move the positioning point C of the robot arm 10 to a point P3 on the spline trajectory ST, which is adjacent to both the target points P2 and P4.

For example, the spline trajectory ST has a larger curvature at the point P3 or thereabout than a curvature at each of the target points P1, P2, P4, and P5. In this example, if the positioning point C of the robot arm 10 can be moved to the target points P2 and P4 while the robot arm 10 has the fully extended posture, it may be difficult to move the positioning point C of the robot arm 10 to the point P3.

From this viewpoint, for this example, the controller 20 calculates, based on the position of each of the points P1 to P5 on the spline trajectory ST and the calculated length of each of the first and second links L1 and L2, the setting movement position TMP for each of the points P1 to P5 on the spline trajectory ST in step S11.

Following the operation in step S11, the controller 20 calculates a temperature difference ΔT21 between a specified usage temperature of, for example, 20° C., of the first link L1 and the reference temperature, and a temperature difference ΔT22 between the specified usage temperature of the second link L2 and the reference temperature, in step S12.

Then, in step S12, the controller 20 calculates a length of each of the first and second links L1 and L2 at the specified usage temperature in accordance with

(1) The reference length, such as 500.0 mm, at the reference temperature, such as 40° C. of the corresponding one of the first and second links L1 and L2

(2) The corresponding one of the temperature differences ΔT21 and ΔT22

(3) The thermal expansion coefficient of the corresponding one of the first and second links L1 and L2

That is, the controller 20 calculates the length of each of the first and second links L1 and L2 at the specified usage temperature of 20° C. of the corresponding one of the first and second links L1 and L2 in the teaching mode in step S12.

Following the operation in step S12, the controller 20 serves as, for example, a rotational angle calculator 20a2 to perform, based on the position of the reference point B, the setting movement position TMP calculated in step S11, and the calculated length of each of the first and second links L1 and L2, a calculation operation to calculate a target rotational angle θT11 for the first joint J1 and a target rotational angle θT12 for the second joint J2 in step S13. The target rotational angles θT11 and θT12 are required for the positioning point C of the robot arm 10 to be moved to the setting movement position TMP.

In other words, the controller 20 performs inverse transform of the setting movement position TMP to the target rotational angle θT11 and target rotational angle θT12 using the position of the reference point B and the calculated length of each of the first and second links L1 and L2 in step S13.

Following the operation in step S13, the controller 20 serves as, for example, a determiner 20a3 to determine whether the positioning point C of the robot arm 10 is movable to the setting movement position TMP in accordance with the calculated target rotational angles θT11 and θT12 in step S14.

Specifically, as illustrated in FIG. 8B, if the controller 20 cannot calculate, based on the position of the reference point B, the setting movement position TMP calculated in step S11, and the calculated length of each of the first and second links L1 and L2, the target rotational angles θT11 and θT12 in step S13, the controller 20 determines that the positioning point C of the robot arm 10 is not movable to the setting movement position TMP (NO in step S14). This situation will be referred to as a positioning-point unmovable situation.

In addition, if the controller 20 determines that the rotational angle of at least one of the first and second joints J1 and J2 required for the positioning point C to match the setting movement position TMP is an invalid angle that exceeding the corresponding maximum rotational angle θmax, the controller 20 determines that the positioning point C of the robot arm 10 is not movable to the setting movement position TMP (NO in step S14). This situation will be referred to as an over-rotation situation.

Upon the determination in step S14 being negative, the specific robot arm positioning routine proceeds to at least one selected operation in the operations of steps S15A to S15F of FIG. 7B. For example, the controller 20 serves as, for example, the information providing module 20a4 to perform at least one selected operation in the operations of steps S15A to S15F.

In contrast, as illustrated in FIG. 9B, if the controller 20 can calculate, based on the position of the reference point B, the setting movement position TMP calculated in step S11, and the calculated e length of each of the first and second links L1 and L2, the target rotational angles θT11 and θT12 in step S13, the controller 20 determines that the positioning point C of the robot arm 10 is movable to the setting movement position TMP (YES in step S14). Then, the specific robot arm positioning routine proceeds to step S16.

Upon selecting the operation in step S15A, the controller 20 supplies, to the teaching pendant 105 and/or the display 110, visual and/or audible information representing that it is difficult to move the positioning point C of the robot arm 10 to the setting movement position TMP at the specified usage temperature of 20° C. This enables the visual and/or audible information, i.e. movement difficult information, representing that it is difficult to move the positioning point C of the robot arm 10 to the setting movement position TMP at the specified usage temperature 20° C. of the robot arm 10 to be provided to a user.

Upon selecting the operation in step S15B, the controller 20 calculates a threshold temperature of the robot arm 10 on or above which it is difficult to move the positioning point C of the robot arm 10 to the setting movement position TMP, and supplies, to the teaching pendant 105 and/or the display 110, visual and/or audible information representing the threshold temperature of the robot arm 10.

Specifically, in step S15B, the controller 20 calculates the threshold temperature of the robot arm 10 at or above which it is difficult to move the positioning point C of the robot arm 10 to the setting movement position TMP in accordance with

(1) The reference length of each of the first and second links L1 and L2 at the reference temperature

(2) The thermal expansion coefficient of each of the first and second links L1 and L2

In step S15B, the controller 20 alternatively calculates the threshold temperature of the robot arm 10 above which the rotational angle of at least one of the first and second joints J1 and J2 exceeds the corresponding maximum rotational angle θmax.

Then, the controller 20 provides the visual and/or audible information, i.e. threshold temperature information, indicative of the threshold temperature to a user via the teaching pendant 105 and/or display 110.

Upon selecting the operation in step S15C, the controller 20 calculates a correction angular direction in which the teaching angle of at least one of the first and second links L1 and L2 in the teaching mode should be corrected, and supplies, to the teaching pendant 105 and/or the display 110, visual and/or audible information representing the correction angular direction for the target point.

For example, in step S15C, the controller 20 calculates, as the correction angular direction, a direction in which the teaching angle of at least one of the first and second links L1 and L2 increases if the determination in step S14 is negative due to the positioning-point unmovable situation.

Then, the controller 20 supplies, to the teaching pendant 105 and/or the display 110, visual and/or audible information representing the correction angular direction for the target point.

If the setting movement position TMP is located at a position to which the robot arm 10 at the temperature of 20° C. is not movable, the visual and/or audible information representing the correction angular direction shows an arrow marker for prompting a user to correct the target point toward the direction indicated by the arrow marker.

As another example, in step S15C, the controller 20 calculates, as the correction angular direction, a direction in which the teaching angle of at least one of the first and second links L1 and L2 decreases if the determination in step S14 is negative due to the over-rotation situation.

Then, the controller 20 supplies, to the teaching pendant 105 and/or the display 110, visual and/or audible information representing the correction angular direction for the target point.

Upon selecting the operation in step S15D, the controller 20 calculates an angular correction amount to which the teaching angle of at least one of the first and second links L1 and L2 in the teaching mode should be corrected, and supplies, to the teaching pendant 105 and/or the display 110, visual and/or audible information representing the angular correction amount for the target point.

For example, in step S15D, the controller 20 calculates, as the angular correction amount, an angular difference θc between the rotational angle of the second link L2 assuming that the positioning point C is located at the setting movement position TMP and the rotational angle of the second link L2 at which the minimum distance between the reference point B and the positioning point C matches with the sum of the length of the first link L1 and the length of the second link L2 at the actual movement-mode temperature if the determination in step S14 is negative due to the positioning-point unmovable situation.

Then, the controller 20 supplies, to the teaching pendant 105 and/or the display 110, visual and/or audible information representing the angular correction amount for the target point.

As another example, in step S15D, the controller 20 calculates, as the angular correction amount, the difference between the calculated rotational angle of the second link L2 at the specified usage temperature of the robot arm 10 and the maximum rotational angle θmax if the determination in step S14 is negative due to the over-rotation situation.

Then, the controller 20 supplies, to the teaching pendant 105 and/or the display 110, visual and/or audible information representing the angular correction amount for the target point.

Upon selecting the operation in step S15E, the controller 20 calculates a correction direction in which the target point taught by the teaching pendant 105 in the teaching mode should be corrected, and supplies, to the teaching pendant 105 and/or the display 110, visual and/or audible information representing the correction direction for the target point.

For example, in step S15E, the controller 20 calculates, as the correction direction, a direction in which the target point becomes closer to the reference point B if the determination in step S14 is negative due to the positioning-point unmovable situation.

Then, the controller 20 supplies, to the teaching pendant 105 and/or the display 110, visual and/or audible information representing the correction direction for the target point.

As another example, in step S15E, the controller 20 calculates, as the correction direction, a direction in which the target point becomes farther from the reference point B if the determination in step S14 is negative due to the over-rotation situation.

Then, the controller 20 supplies, to the teaching pendant 105 and/or the display 110, visual and/or audible information representing the correction direction for the target point.

Upon selecting the operation in step S15F, the controller 20 calculates a correction amount to which the target point in the teaching mode should be corrected, and supplies, to the teaching pendant 105 and/or the display 110, visual and/or audible information representing the correction amount for the target point.

For example, in step S15F, the controller 20 calculates the rotational angle of the second link L2 at which the minimum distance between the reference point B and the positioning point C matches with the sum of the length of the first link L1 and the length of the second link L2 at the specified usage temperature of the robot arm 10 if the determination in step S14 is negative due to the positioning-point unmovable situation. Then, in step S15F, the controller 20 converts the calculated rotational angle of the second link L2 to a corrected position, and calculates, as the correction amount, a difference between the setting movement position TMP and the corrected position. Thereafter, the controller 20 supplies, to the teaching pendant 105 and/or the display 110, visual and/or audible information representing the correction amount for the target point.

As another example, in step S15F, the controller 20 converts the calculated rotational angle of the second link L2 at the actual movement-mode temperature into a first position, and converts the maximum rotational angle θmax into a second position if the determination in step S14 is negative due to the over-rotation situation. Then, in step S15F, the controller 20 calculates, as the correction amount, the difference between the calculated first position and the calculated second position.

Thereafter, the controller 20 supplies, to the teaching pendant 105 and/or the display 110, visual and/or audible information representing the correction amount for the target point.

Otherwise, in step S16, the controller 20 provides, to a user via the teaching pendant 105 and/or display 110, visible and/or audible information, which is referred to as arm movable information, representing that the positioning point C of the robot arm 10 is movable to the setting movement position TMP at the specified usage temperature.

Additionally, as instructed by a user using the teaching pendant 105, the controller 20 performs, at the specified usage temperature of the robot arm 10, the feedback control task that controls the motor M of each of the first and second joints J1 and J2 such that

(1) The deviation of the actual rotational angle θ1 of the first link L1, which is fed back from the encoder 11, from the target rotational angle θT11 becomes zero to thereby match the actual rotational angle θ1 with the target rotational angle θT11

(2) The deviation of the actual rotational angle θ2 of the second link L2, which is fed back from the encoder 12, from the target rotational angle θT12 becomes zero to thereby match the actual rotational angle θ2 with the target rotational angle θT12 (see step S6)

As described above, the controller 20 of the robot system 100 according to the first embodiment is configured to perform, based on the length of each of the first and second links L1 and L2 at the specified usage temperature of the robot arm 10, a calculation operation to calculate the target rotational angle θT11 for the first joint J1 and the target rotational angle θT12 for the second joint J2 (see step S13).

If the calculation operation enables the target rotational angle θT11 for the first joint J1 and the target rotational angle θT12 for the second joint J2 to be validly calculated, it is possible to determine that the positioning point C of the robot arm 10 is movable to the setting movement position TMP at the specified usage temperature of the robot arm 10 (see YES in step S14).

Otherwise, if it is difficult for the calculation operation to validly calculate at least one of the target rotational angle θT11 for the first joint J1 and the target rotational angle θT12 for the second joint J2, it is possible to determine that the positioning point C of the robot arm 10 is not movable to the setting movement position TMP at the specified usage temperature of the robot arm 10 (see NO in step S14).

Note that the situation where the target angle for at least one of first and second joints J1 and J2 is validly calculated represents that the calculated target angle is within the corresponding maximum rotational angle for the at least one of the first and second joints J1 and J2.

That is, this configuration of the controller 20 enables whether the positioning point C of the robot arm 10 is movable to the setting movement position TMP at the specified usage temperature of the robot arm 10 to be determined depending on whether the calculation operation validly calculates the target rotational angle θT11 for the first joint J1 and the target rotational angle θT12 for the second joint J2.

This makes it possible to determine whether to move, at the specified usage temperature of the robot arm 10, the positioning point C of the robot arm 10 to the setting movement position TMP that was determined at the teaching-mode temperature.

The controller 20 is configured to determine that the positioning point C of the robot arm 10 is not movable to the setting movement position TMP at the specified usage temperature of the robot arm 10 upon determining that

(1) The controller 20 cannot calculate the target rotational angles θT11 and θT12 required for the positioning point C to match the setting movement position TMP or

(2) The target rotational angle of at least one of the first and second joints J1 and J2 required for the positioning point C to match the setting movement position TMP is set as an ineffective angle.

This configuration results in easy determination that the positioning point C of the robot arm 10 is not movable to the setting movement position TMP at the specified usage temperature of the robot arm 10.

The controller 20 is configured to determine that the positioning point C of the robot arm 10 is movable to the setting movement position TMP at the specified usage temperature of the robot arm 10 upon determining that the controller 20 can validly calculate the target rotational angles θT11 and θT12 required for the positioning point C to match the setting movement position TMP.

This configuration results in easy determination that the positioning point C of the robot arm 10 is movable to the setting movement position TMP at the specified usage temperature of the robot arm 10.

If the teaching-mode movement position is the point P3 in the points P1 to P5 on the spline trajectory ST, the controller 20 is capable of determining whether the positioning point C of the robot arm 10 is movable to the point P3 as the setting movement position TMP at the specified usage temperature of the robot arm 10.

That is, upon determining that the positioning point C of the robot arm 10 is movable from, for example, the adjacent target point P2 or P4, to the point P3 as the setting movement position TMP at the specified usage temperature of the robot arm 10, the controller 20 provides, to a user, visible and/or audible information that the positioning point C of the robot arm 10 is movable, from, for example, the adjacent target point P2 or P4, to the point P3 as the setting movement position TMP at the specified usage temperature of the robot arm 10. This enables a user to check whether the positioning point C of the robot arm 10 is movable to the point P3 on the spline trajectory at the specified usage temperature of the robot arm 10 during teaching of the target points P1, P2, P4, and P5. This reduces the occurrence of need to teach the target points P1, P2, P4, and P5 again, and reduces the possibility of the robot system 100 malfunctioning after installation of the robot system 100 into one of various facilities.

Upon determination that the positioning point C of the robot arm 10 is not movable to the setting movement position TMP at the specified usage temperature of the robot arm 10, the controller 20 provides, to a user, visual and/or audible information indicative of the threshold temperature of the robot arm 10 on or above which it is difficult to move the positioning point C of the robot arm 10 to the setting movement position TMP. This enables a user to easily determine whether the positioning point C of the robot arm 10 is not movable to the setting movement position TMP on the basis of an ambient temperature of the robot arm 10 and/or the usage conditions of the robot arm 10.

Upon determination that the positioning point C of the robot arm 10 is not movable to the setting movement position TMP at the specified usage temperature of the robot arm 10, the controller 20 provides, to a user, visual and/or audible information indicative of a correction angular direction in which the teaching angle of at least one of the first and second links L1 and L2 in the teaching mode should be corrected.

This makes it possible for a user to easily know, when teaching a target point in the teaching mode, the correction angular direction of the teaching angle of at least one of the first and second links L1 and L2; the correction angular direction enables the positioning point C of the robot arm 10 to be moved to the setting movement position TMP.

Upon determination that the positioning point C of the robot arm 10 is not movable to the setting movement position TMP at the specified usage temperature of the robot arm 10, the controller 20 provides, to a user, visual and/or audible information indicative of an angular correction amount to which the teaching angle of at least one of the first and second links L1 and L2 in the teaching mode should be corrected.

This makes it possible for a user to easily know, when teaching a target point in the teaching mode, the angular correction amount of the teaching angle of at least one of the first and second links L1 and L2; the angular correction amount enables the positioning point C of the robot arm 10 to be moved to the setting movement position TMP.

Upon determination that the positioning point C of the robot arm 10 is not movable to the setting movement position TMP at the specified usage temperature of the robot arm 10, the controller 20 provides, to a user, visual and/or audible information indicative of a correction direction in which the target point taught by the teaching pendant 105 in the teaching mode should be corrected.

This makes it possible for a user to easily know, when teaching a target point in the teaching mode, the correction direction of the target point; the correction direction enables the positioning point C of the robot arm 10 to be moved to the setting movement position TMP.

Upon determination that the positioning point C of the robot arm 10 is not movable to the setting movement position TMP at the specified usage temperature of the robot arm 10, the controller 20 provides, to a user, visual and/or audible information indicative of a correction amount to which target point in the teaching mode should be corrected.

This makes it possible for a user to easily know, when teaching a target point in the teaching mode, the correction amount of the target point; the correction amount of the target point enables the positioning point C of the robot arm 10 to be moved to the setting movement position TMP.

As described above, the controller 20 according to the first embodiment is configured to determine whether the positioning point C of the robot arm 10 is movable to the setting movement position TMP at a specified usage temperature of the robot arm 10 during the teaching of the target point to the controller 20 by a user, but the present disclosure is not limited thereto. Specifically, the controller 20 according to the first embodiment can be configured to determine whether the positioning point C of the robot arm 10 is movable to the setting movement position TMP at a specified usage temperature of the robot arm 10 during operation check test of the robot system 100 in a simulation mode.

That is, the controller 20 of the robot system 100 according to the first embodiment can be configured to

(1) Calculate, based on the position of a target point and a calculated length of each of the first and second links L1 and L2 at a predetermined setting temperature in the simulation mode, a setting movement position TMP to which the positioning point C of the robot arm 10 actually moves in the simulation mode (see step S11)

(2) Calculate the temperature difference ΔT21 between a specified usage temperature of, for example, 20° C., of the first link L1 and the reference temperature, and the temperature difference ΔT22 between the specified usage temperature of the second link L2 and the reference temperature (see step S12)

(3) Determine whether the positioning point C of the robot arm 10 is movable to the setting movement position TMP at the specified usage temperature of the robot arm 10 (see steps S13 and S14)

### Second Embodiment

The following describes the second embodiment of the present disclosure, to which the present disclosure has been applied, with reference to FIGS. 3, 4, and 7.

The robot system according to the second embodiment differs from the robot system 100 in the following points. So, the following mainly describes the different points of the robot system according to the second embodiment, and omits or simplifies descriptions of like parts between the first and second embodiments, to which identical or like reference characters are assigned, thus eliminating redundant description.

The robot system 100 is configured such that the farthest position, to which the positioning point P is movable, relative to the reference point B is the position of the positioning point P while the robot arm 10 has the fully extended posture as illustrated in FIG. 3.

Thus, as illustrated in FIG. 3, if the setting movement position TMP taught in the teaching mode at the temperature of, for example, 60° C. is located to be farther than the positioning point P while the robot arm 10 has the fully extended posture, it is difficult to move the positioning point P of the robot arm 10 to the setting movement position TMP.

From this viewpoint, the controller 20 includes a length calculator 20a5 configured to calculate

1. The minimum distance from the reference point B to the setting movement position TMP

2. The length of the robot arm 10 from the reference point B to the positioning point C while the robot arm 10 has the fully extended posture.

Note that the length calculator 20a5 is illustrated in FIG. 1 using a phantom line. That is, the length calculator 20a5 can be eliminated from the controller 20 of the first embodiment.

Then, the controller 20 serves as, for example, the determiner 20a4 to determine whether the positioning point C of the robot arm 10 is movable to the setting movement position TMP at a specified usage temperature of the robot arm 10 in accordance with a comparison between the minimum distance from the reference point B to the setting movement position TMP and the length of the robot arm 10 from the reference point B to the positioning point C while the robot arm 10 has the fully extended posture in step S14. The length of the robot arm 10 from the reference point B to the positioning point C while the robot arm 10 has the fully extended posture will be referred to as a fully extending length.

Specifically, upon determination that the minimum distance from the reference point B to the setting movement position TMP is longer than the fully extending length of the robot arm 10 from the reference point B to the positioning point C, the controller 20 determines that the positioning point C of the robot arm 10 is not movable to the setting movement position TMP at the specified usage temperature of the robot arm 10 (NO in step S14).

In contrast, upon determination that the minimum distance from the reference point B to the setting movement position TMP is equal to or shorter than the fully extending length of the robot arm 10 from the reference point B to the positioning point C, the controller 20 determines that the positioning point C of the robot arm 10 is movable to the setting movement position TMP at the specified usage temperature of the robot arm 10 (YES in step S14).

For example, because the robot arm 10 at the temperature of 20° C. has the fully extending length of 999.6 mm, affirmative determination in step S14 is carried out as long as the minimum distance from the reference point B to the setting movement position TMP is equal to or shorter than 999.6 mm (see FIG. 3).

Note that the determination in step S14 according to the second embodiment uses an additional requirement that the rotational angle of each of the first and second joints J1 and J2 is equal to or smaller than the maximum rotational angle θmax.

That is, as illustrated in FIG. 5, although the minimum distance from the reference point B to the setting movement position TMP is equal to or shorter than the fully extending length of 999.6 mm of the robot arm 10, because the rotational angle of the second joint J2 exceeds the maximum rotational angle θmax, negative determination in step S14 is carried out.

As described above, the controller 20 according to the second embodiment is configured to determine whether the positioning point C of the robot arm 10 is movable to the setting movement position TMP at a specified usage temperature of the robot arm 10 in accordance with a comparison between the minimum distance from the reference point B to the setting movement position TMP and the fully extending length of the robot arm 10 from the reference point B to the positioning point C. This configuration enables whether the positioning point C of the robot arm 10 is movable to the setting movement position TMP to be more easily and more rapidly determined.

The controller 20 according to the second embodiment can provide, to a user, only one of

(1) Visible and/or audible information representing that the positioning point C of the robot arm 10 is not movable to the setting movement position TMP at the specified usage temperature

(2) Visible and/or audible information representing that the positioning point C of the robot arm 10 is movable to the setting movement position TMP at the specified usage temperature

The controller 20 according to the second embodiment is configured to determine whether the positioning point C of the robot arm 10 is movable to the setting movement position TMP at a specified usage temperature of the robot arm 10 during the teaching of the target point to the controller 20 by a user, but the present disclosure is not limited thereto.

Specifically, the controller 20 according to the second embodiment can be configured to determine whether the positioning point C of the robot arm 10 is movable to the setting movement position TMP at a specified usage temperature of the robot arm 10 during operation check test of the robot system 100 in a simulation mode.

That is, the controller 20 of the robot system 100 according to the second embodiment can be configured to

(1) Calculate, based on the position of a target point and a calculated length of each of the first and second links L1 and L2 at a predetermined setting temperature in the simulation mode, a setting movement position TMP to which the positioning point C of the robot arm 10 actually moves in the simulation mode (see step S11)

(2) Calculate the temperature difference ΔT21 between a specified usage temperature of, for example, 20° C., of the first link L1 and the reference temperature, and the temperature difference ΔT22 between the specified usage temperature of the second link L2 and the reference temperature (see step S12)

(3) Determine whether the positioning point C of the robot arm 10 is movable to the setting movement position TMP at the specified usage temperature of the robot arm 10 in accordance with a comparison between the minimum distance from the reference point B to the setting movement position TMP and the fully extending length of the robot arm 10 from the reference point B to the positioning point C (see step S14)

The controller 20 according to each of the first and second embodiment can be configured to perform both the determination operation in step S14 according to the first embodiment and the determination operation in step S14 according to the second embodiment, or perform any one of the determination operation in step S14 according to the first embodiment and the determination operation in step S14 according to the second embodiment.

The reference point B is limited to the center of the end surface of the first end of the first link L1, but can be set to the intermediate portion of the robot arm 10 between the first joint J1 and the second joint J2.

The teaching mode and the simulation mode are an example of a setting mode for setting a target point for the robot arm 10.

The usage temperature of the robot arm 20 can be freely specified depending on the operation environment temperature around the robot arm 10 and/or the heating state of the robot arm 10.

The controller 20 calculates the actual length of each of the first and second links L1 and L2 at the teaching-mode temperature of the robot arm 10 in step S10, and calculates the actual length of each of the first and second links L1 and L2 at the specified usage temperature of the robot arm 10, but the present disclosure is not limited thereto. Specifically, the controller 20 can be configured to have calculated the relationship between the variable of the actual length of each of the first and second links L1 and L2 and the variable of the temperature of the robot arm 10, and have stored the information about the relationship in the memory unit 20b. Then, in step S10, the controller 20 can obtain the actual length of each of the first and second links L1 and L2 at the teaching-mode temperature of the robot arm 10 using the relationship stored in the memory unit 20b, and can obtain the actual length of each of the first and second links L1 and L2 at the specified usage temperature of the robot arm 10 using the relationship stored in the memory unit 20b in step S12.

If the controller 20 causes the robot arm 10 to move the positioning point C from a target point to a predetermined point that is located away from the target point by a predetermined distance in a predetermined direction, the controller 20 can set the predetermined point as the setting movement position TMP.

The robot arm 10 is configured as a vertically articulated robot including the base pole 15 having the first axis, the assembly of the first joint J1 and the first link L1 having the second axis, and the assembly of the second joint J2 and the second link L2 having the third axis, but the present disclosure is not limited thereto. Specifically, the controller 20 can be applied to a horizontal articulated robot including the assembly of the first joint J1 and the first link L1 having the first axis, and the assembly of the second joint J2 and the second link L2 having the second axis.

The controller 20 can be applied to a manipulator including at least two links and at least one joint that joins the at least two links such that the links are rotatable relative to each other.

While the illustrative embodiments of the present disclosure have been described herein, the present disclosure is not limited to the embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An apparatus for determining whether a manipulator is operable, the manipulator comprising at least a first link, a second link, and at least one joint that joins the first and second links such that the first and second links are rotatable relative to each other about a predetermined rotational axis, the apparatus comprising:
a movement position calculating unit configured to calculate, in a setting mode for setting a target point to which a predetermined point of the manipulator is to be moved, a setting movement position in accordance with a length of each of the first and second links at a temperature in the setting mode and the target point,
the setting movement position representing a position to which the predetermined point of the manipulator will be moved at the temperature in the setting mode, the length of each of the first and second links at the temperature in the setting mode being referred to as a setting-mode length;
a rotational angle calculator configured to perform, based on a length of each of the first and second links at a specified temperature of the manipulator, a calculation operation to calculate a target rotational angle of at least one of the first and second links based on operation of the joint, the target rotational angle of at least one of the first and second links based on operation of the joint being required for the predetermined point of the manipulator to be moved toward the setting movement position; and
a determiner configured to determine, based on the target rotational angle of at least one of the first and second links, whether the predetermined point of the manipulator is movable to the setting movement position at the specified temperature of the manipulator.

2. The apparatus according to claim 1, wherein:
the determiner is configured to determine that the predetermined point of the manipulator is not movable to the setting movement position at the specified temperature of the manipulator upon at least one of:
the calculation operation having difficulty in calculating the target rotational angle of at least one of the first and second links; and
the target rotational angle of at least one of the first and second links being an invalid angle based on operation of the joint.

3. The apparatus according to claim 1, wherein:
the determiner is configured to determine that the predetermined point of the manipulator is movable to the setting movement position at the specified temperature of the manipulator upon the target rotational angle of at least one of the first and second links being validly calculated by the angle calculator.

4. The apparatus according to claim 1, wherein:
the target point comprises a plurality of target points that are located on a predetermined trajectory; and
the movement position calculating unit is configured to calculate, in the setting mode for setting each target point, a point on the trajectory as the setting movement position.

5. The apparatus according to claim 1, wherein:
the predetermined point is set to the first link; and
the manipulator has a predetermined reference point set to the second link,
the apparatus further comprising:
a second determiner configured to:
perform a comparison between:
a minimum distance from the reference point to the setting movement position at the temperature of the setting mode; and
a length of the first and second links from the reference point to the predetermined point while the first and second links fully extend to be aligned with each other at the specified temperature of the manipulator; and
determine, based on the comparison, whether the predetermined point of the manipulator is movable to the setting movement position at the specified temperature of the manipulator.

6. The apparatus according to claim 1, further comprising:
an information providing unit configured to provide, to a user of the manipulator, information representing that the predetermined point of the manipulator is not movable to the setting movement position at the specified temperature of the manipulator upon determination that the predetermined point of the manipulator is not movable to the setting movement position at the specified temperature of the manipulator.

7. The apparatus according to claim 1, further comprising:
an information providing unit configured to provide, to a user of the manipulator, information representing a threshold temperature of the manipulator on or above which it is difficult to move the predetermined point of the manipulator to the setting movement position upon determination that the predetermined point of the manipulator is not movable to the setting movement position at the specified temperature of the manipulator.

8. The apparatus according to claim 1, further comprising:
an information providing unit configured to provide, to a user of the manipulator, information representing a correction angular direction in which a rotational angle of at least one of the first and second links used to set the target point in the setting mode should be corrected upon determination that the predetermined point of the manipulator is not movable to the setting movement position at the specified temperature of the manipulator.

9. The apparatus according to claim 1, further comprising:
an information providing unit configured to provide, to a user of the manipulator, information representing that a correction angular direction in which an angular correction amount of at least one of the first and second links used to set the target point in the setting mode should be corrected upon determination that the predetermined point of the manipulator is not movable to the setting movement position at the specified temperature of the manipulator.

10. The apparatus according to claim 1, further comprising:
an information providing unit configured to provide, to a user of the manipulator, information representing a correction direction in which the target point in the setting mode should be corrected upon determination that the predetermined point of the manipulator is not movable to the setting movement position at the specified temperature of the manipulator.

11. The apparatus according to claim 1, further comprising:
an information providing unit configured to provide, to a user of the manipulator, information representing a correction amount to which the target point in the setting mode should be corrected upon determination that the predetermined point of the manipulator is not movable to the setting movement position at the specified temperature of the manipulator.

12. An apparatus for determining whether a manipulator is operable, the manipulator comprising at least a first link, a second link, and at least one joint that joins the first and second links such that the first and second links are rotatable relative to each other about a predetermined rotational axis, the apparatus comprising:
a movement position calculating unit configured to calculate, in a setting mode for setting a target point to which a predetermined point of the first link of the manipulator is to be moved, a setting movement position in accordance with a length of each of the first and second links at a temperature in the setting mode and the target point,
the setting movement position representing a position to which the predetermined point of the manipulator will be moved at the temperature in the setting mode, the length of each of the first and second links at the temperature in the setting mode being referred to as a setting-mode length,
the second link having a predetermined reference point set thereto; and
a determiner configured to:
perform a comparison between:
a minimum distance from the reference point to the setting movement position at the temperature of the setting mode; and
a length of the first and second links from the reference point to the predetermined point while the first and second links fully extend to be aligned with each other at the specified temperature of the manipulator; and
determine, based on the comparison, whether the predetermined point of the manipulator is movable to the setting movement position at the specified temperature of the manipulator.

13. The apparatus according to claim 12, wherein:
the determiner is configured to determine that the predetermined point of the manipulator is not movable to the setting movement position at the specified temperature of the manipulator upon the minimum distance from the reference point to the setting movement position at the temperature of the setting mode being longer than the length of the first and second links from the reference point to the predetermined point while the first and second links fully extend to be aligned with each other at the specified temperature of the manipulator.

14. The apparatus according to claim 12, wherein:
the determiner is configured to determine that the predetermined point of the manipulator is movable to the setting movement position at the specified temperature of the manipulator upon the minimum distance from the reference point to the setting movement position at the temperature of the setting mode being equal to or shorter than the length of the first and second links from the reference point to the predetermined point while the first and second links fully extend to be aligned with each other at the specified temperature of the manipulator.

15. The apparatus according to claim 12, further comprising:
an information providing unit configured to provide, to a user of the manipulator, information representing that the predetermined point of the manipulator is not movable to the setting movement position at the specified temperature of the manipulator upon determination that the predetermined point of the manipulator is not movable to the setting movement position at the specified temperature of the manipulator.

16. The apparatus according to claim 12, further comprising:
an information providing unit configured to provide, to a user of the manipulator, information representing a threshold temperature of the manipulator on or above which it is difficult to move the predetermined point of the manipulator to the setting movement position upon determination that the predetermined point of the manipulator is not movable to the setting movement position at the specified temperature of the manipulator.

17. The apparatus according to claim 12, further comprising:
an information providing unit configured to provide, to a user of the manipulator, information representing a correction angular direction in which a rotational angle of at least one of the first and second links used to set the target point in the setting mode should be corrected upon determination that the predetermined point of the manipulator is not movable to the setting movement position at the specified temperature of the manipulator.

18. The apparatus according to claim 12, further comprising:
an information providing unit configured to provide, to a user of the manipulator, information representing a correction angular direction in which an angular correction amount of at least one of the first and second links used to set the target point in the setting mode should be corrected upon determination that the predetermined point of the manipulator is not movable to the setting movement position at the specified temperature of the manipulator.

19. The apparatus according to claim 12, further comprising:
an information providing unit configured to provide, to a user of the manipulator, information representing a correction direction in which the target point in the setting mode should be corrected upon determination that the predetermined point of the manipulator is movable to the setting movement position at the specified temperature of the manipulator.

20. The apparatus according to claim 12, further comprising:
an information providing unit configured to provide, to a user of the manipulator, information representing a correction amount to which the target point in the setting mode should be corrected upon determination that the predetermined point of the manipulator is not movable to the setting movement position at the specified temperature of the manipulator.
